(19) United States
(12) Patent Application Publication
(10) Pub. No.: US 2004/0218731 A1
(43) Pub. Date: Nov. 4, 2004

(54) Communications assistance for law enforcement act (CALEA) device

(76) Inventors: Bizhan Karimi-Cherkandi, Boca Raton, FL (US); Farrokh Mohammadzadeh Kouchri, Boca Raton, FL (US)

Correspondence Address: Elsa Keller, Siemens Corporation, Intellectual Property Department, 170 Wood Avenue South, Iselin, NJ, 08830, US

(21) Appl. No.: 10/809,629

(22) Filed: Mar. 25, 2004

Related U.S. Application Data
(60) Provisional application No. 60/457,347, filed on Mar. 25, 2003.

(30) Foreign Application Priority Data
Aug. 14, 2003 (GB) 0319051.9
Aug. 14, 2003 (GB) 0319048.5
Aug. 14, 2003 (GB) 0319050.1

(51) Int. Cl. H04M 1/24; H04M 3/08; H04M 3/22; H04M 1/56; H04M 15/06

(52) U.S. Cl. 379/32.01; 379/32.05; 379/35; 379/142.07

(57) ABSTRACT

Monitoring calls in compliance with a law enforcement regulation or governmental law or order in a telecommunications network is provided. A law enforcement application executes commands that effect the law enforcement regulation. A primary rate interface (PRI) coupled to the law enforcement application redirects calls to be regulated by law enforcement regulation. A method for effecting a law enforcement regulation in a telecommunications network provides a law enforcement application is that regulates calls and a primary rate interface (PRI) for redirecting the calls to be regulated by law enforcement regulation.

### Priority of Invention

The instant application claims priority to the U.S. Provisional Application Ser. No. 60/457,347 filed Mar. 25, 2003, entitled ‘AIN-CALEA;’ and the GB Patent Application Nos. GB 0319050.1 filed Aug. 14, 2003, entitled ADVANCED INTELLIGENT NETWORK (AIN) FOR ASSISTING COMMUNICATIONS ASSISTANCE FOR LAW ENFORCEMENT ACT (CALEA); GB 0319048.5 filed Aug. 14, 2003, entitled AIN-CALEA VIRTUAL COMMUNICATIONS ASSISTANCE FOR LAW ENFORCEMENT ACT (CALEA) DEVICE and GB 0319051.9 filed Aug. 14, 2003, entitled COMMUNICATIONS ASSISTANCE FOR LAW ENFORCEMENT ACT (CALEA) DEVICE, the contents of all of which are incorporated in their entirety herein.

### BACKGROUND

1. Field of the Invention

The present invention relates to a Communications Assistance for Law Enforcement Act (CALEA) device and, more particularly, to providing a CALEA device to capture call data and call content using a primary rate interface (PRI) connection.

2. Related Information

The Communications Assistance for Law Enforcement Act (CALEA) was passed in the United States in 1994 in response to rapid advances in telecommunications technology. The implementation of digital technology and wireless services, for example, have almost outpaced the ability of law enforcement officials to conduct authorized electronic surveillance. The Federal Communications Commission (FCC) has been tasked with enforcing the CALEA provisions to ensure that technology does not avert the will of law. CALEA requires telecommunications Carriers to ensure that their equipment, facilities, and services are able to comply with authorized electronic surveillance. Problematically, these assistance capabilities were not fully met by the deadline set by the FCC and deadlines for compliance were repeatedly extended in order to allow the Carriers to comply.

A primary difficulty is that many Carriers are simply not equipped to provide the required capabilities. Technical requirements or standards for CALEA capabilities are not trivial and have been established for several categories of telecommunications by industry associations or standard-setting organizations, in consultation with the FCC.

Providing a device that offers a CALEA functionality is not a trivial undertaking. The CALEA device must work with the existing telecommunications networks. And, it must do so with the least amount of cost to the telecommunications carriers.

In addition, there is the problem that the CALEA subject may become aware that the call is redirected, thereby possibly alerting the subject that the call is monitored. This is particularly a problem with complex systems that attempt to emulate CALEA, as it may be the case that the set up time may cause a delay or change in quality of the call.

What is needed is a device that implements CALEA, yet incorporates the existing systems. A device is needed that implements CALEA, but does not alert the subject to the call being redirected.

### OBJECTS & SUMMARY OF THE INVENTION

An object of the present invention is to provide a CALEA device.

An object of the present invention is to provide a CALEA device that is not complex and costly.

An object of the present invention is to provide a CALEA device that does not sense the redirection of the call. This device is an external device and is switch independent (i.e. it has no impact on the switching functions of the switch).

In accordance with the objects of the present invention, there is provided an apparatus for monitoring a call in compliance with a law enforcement regulation or governmental law or order in a telecommunications network. A law enforcement application executes commands that effect the law enforcement regulation. A primary rate interface (PRI) coupled to the law enforcement application receives the redirected calls (from the switch) to be regulated by law enforcement regulation.

There is also provided a method for monitoring a call in compliance with a law enforcement regulation or governmental law or order in a telecommunications network. A step of providing a law enforcement application is that regulates calls. A step provides a primary rate interface (PRI) for receiving redirected calls and forwarding the calls to the dialed destination be regulated by law enforcement regulation.

### BRIEF DESCRIPTION OF THE DRAWINGS

The following figures illustrate the present invention in particular detail, and it shall be considered that the figures are merely examples:

FIG. 1 is a block diagram illustrating the present invention; and

FIG. 2 is a flow diagram of the present invention.

### DETAILED DESCRIPTION OF THE PREFERRED EMBODIMENTS

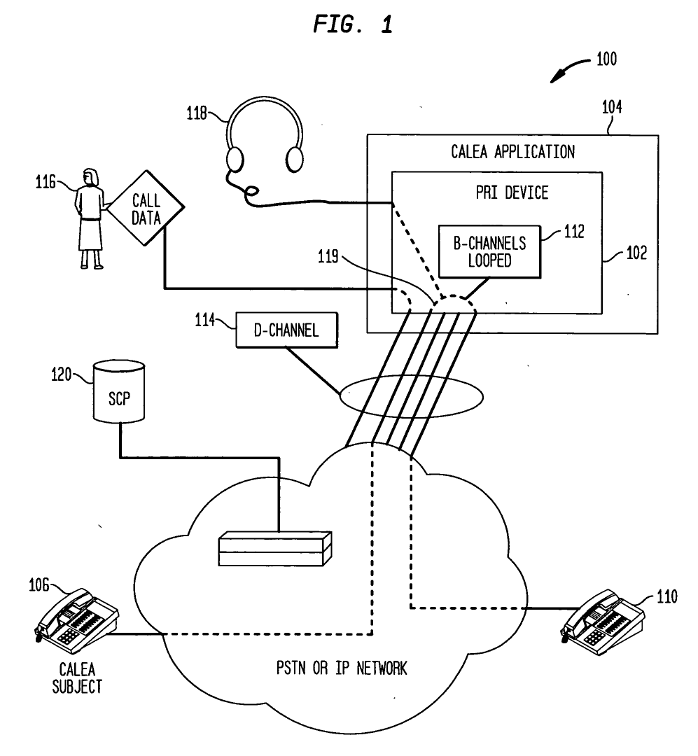

The present invention is illustrated in FIG. 1, wherein there is shown a primary rate interface (PRI) device facilitating AIN-CALEA 100.

It shall be intuitive to first discuss PRI. In the Integrated Services Digital Network (ISDN), there are two levels of service: the Basic Rate Interface (BRI), intended for the home and small enterprise, and the Primary Rate Interface (PRI), for larger users. Both rates include a number of B-channels and a D-channel. Each B-Channel carries data, voice, and other services. The D-Channel carries control and signaling information. This invention intends to use a device having PRI access.

The Basic Rate Interface consists of two 64 Kbps B-channels and one 16 Kbps D-channel. Thus, a Basic Rate Interface user can have up to 128 Kbps service. The Primary Rate Interface consists of 23 B-channels and one 64 Kpbs D-channel using a T-1 line or 30 B-channels and 1 D-channel using an E1 line. Thus, a Primary Rate Interface user on a T-1 line can have up to 1.544 Mbps service or up to 2.048 Mbps service on an E1 line. PRI uses the Q.931 protocol over the D-channel.

The Primary Rate Interface channels are carried on a T-carrier system line (in the U.S., Canada, and Japan) or an E-carrier line (in other countries) and are typically used by medium to large enterprises. The 23 (or 30) B-channels can be used flexibly and reassigned when necessary to meet special needs such as videoconferences. The Primary Rate user may be hooked up directly to the telephone company central office. Of course, the PRI may have a different channel scheme as here.

In a given ISDN connection, such as PRI, the ISDN protocol demands that each end of the connection assumes one of the two roles of communication. The roles are defined as network-side and user-side. Based on the role, the two ends perform different tasks in particular with regards to authentication of the origination (calling) or termination (called) party/number. In either case, both the calling number and the called numbers are included within the calling information as part of the set-up of an ISDN phone call. This information is provided to the switches as part of the call routing and authentication, and in the case of the called party, the calling party's number is typically displayed within the called party's ISDN device.

If the role of network-side is assumed, the calling party's number (but not the called party's number) may be subject to authentication, and the call may be rejected if the authentication is not provided. The authenticated call shall be routed or terminated based on the called number. If the role of user-side is assumed, then authentication of the calling number is not typically performed and the call is routed or terminated based on the called number.

As one example, this authentication is illustrated in a configuration where a PBX is connected to a PSTN. Calls originated from PBX (assuming user-side) towards PSTN (assuming network-side) are mainly subject of authentication in the PSTN switch based on the calling number. This is done based on the fact that PSTN has a database of all subscribers (or groups of subscribers) within the PBX. A call with an unauthorized calling number will be rejected. If the calling number is not presented at the stage of initiation, then PSTN may insert a default calling number defined for that PBX. In a TDM environment, there are situations where two PSTNs may wish to connect to each other through a PRI interface. In this case, each shall accept one of the two roles (network-side or user-side).

With respect to authentication of a CALEA subject of FIG. 1, for example, if a CALEA subject 106 places a call over the PSTN, then the service control point 120 checks the incoming calling number of the party. If that party is not an authorized surveillance subject, then the call is routed in normal fashion to the switch that normally services calls from terminal 106.

However, if the party using terminal 106 is an authorized surveillance subject, then the SCP authorizes the interception of the call and the called number is redirected to the CALEA application 104. The present invention takes advantage of the information within the PRI call and the associated access capability of the CALEA application. In particular, the CALEA application is capable of setting a PRI call to carry any calling number/ID and called number/ID such that the network will accept the delivery of the call. This is different than other network access devices such as a regular telephone. By revising the calling ID and called ID, the CALEA subject or its intended called party does not sense the redirection of the call. This assumes a special configuration in the switch with the CALEA application to recognize the switch as a network-side PRI. This provides the CALEA-application the capability to originate a call with any calling number.

Thus, as shown in FIG. 1, a PRI-Device 102 is provided to assist a CALEA application 104. When the CALEA subject 106 initiates a call, for example, through a network 108 to a destination 110, the call is redirected by the switch (e.g. with the aid of AIN triggers or the plain call forwarding feature) to the PRI-CALEA device where the call is managed by the PRI device 102. The network 108 may be any type of network, including a PSTN (or IP network). Each call offered to this device uses the B-channel 112. That is, the voice is conveyed over the B-channel 112 and is captured. The call data is conveyed on the D-channel 114, for example, User-User Information (UUI) as supplementary data, calling party ID, called party ID, or nature of access.

Using the call data, the invention originates a call and loops 112 the B-Channel 119 to the destination 110. The call data 114 is forwarded by the PRI device 102 to the CALEA operator 116 and the voice signal may be forwarded to a remote location 118 which may terminate in a terminal, such as a recorder or head set for example.

The network 108 determines whether to forward the call to the CALEA device with the assistance, for example, of a Service Control Point 110 (SCP) 120. The SCP 120 which determines how to handle the traffic and a CALEA device 112, also called a CALEA facility, that provides CALEA functionality.

The PRI device 102 in one aspect may be a PRI card. The PRI card may be installed in a computer, such as a personal computer (PC), where the CALEA application 104 is running.

While the present invention has been described with reference to a CALEA device, the invention is not limited to a particular ratification of CALEA, and covers monitoring a call in compliance with a law enforcement regulation, either by government law or order as promulgated by governmental agency or by statute.

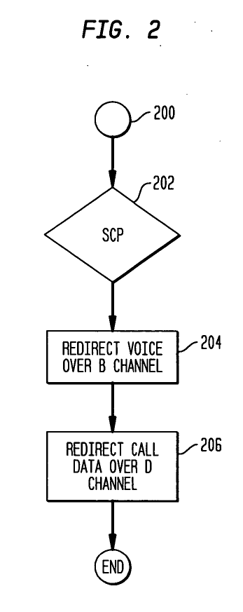

The invention also relates to a method 200 for establishing a CALEA functionality using a PRI device as shown in FIG. 2. In step 202, the SCP decides whether CALEA is to be applied to the call. In step 204, the invention, applying a PRI device, redirects the voice signal over the B-channel. In step 206, the call data is redirected over the D-Channel and the process ends.

The present invention has, thus, been described with reference to the detailed figures, and it shall be appreciated that the invention is not so limited to the particular aspects or embodiments shown, but encompasses the broader invention contemplated herein.

1. An apparatus for monitoring a call in a telecommunications network in compliance with a governmental regulation, comprising:
an application for executing commands that effect the governmental regulation for monitoring the call; and
a primary rate interface (PRI) coupled to the application for redirecting calls to be monitored in compliance with governmental regulation.

2. The apparatus of claim 1, wherein the PRI carries any calling ID and called ID, such that there is no indication to a caller of a redirection of the call.

3. The apparatus of claim 1, wherein the governmental regulation is established by the Communications Assistance for Law Enforcement Act (CALEA).

4. The apparatus of claim 1, wherein the PRI includes a B-Channel that conveys voice signals and the PRI loops the voice signals to a termination point.

5. The apparatus of claim 1, wherein the PRI includes a D-Channel that conveys call data and the PRI forwards the call data to an operator.

6. The apparatus of claim 1, wherein the PRI is a personal computer (PC) card.

7. The apparatus of claim 1, further comprising a Service Control Point that determines whether a particular call is to be regulated.

8. The apparatus of claim 1, wherein the network is a public switched telephone network PSTN.

9. The apparatus of claim 1, wherein network is an Internet Protocol (IP) network.

10. A method for monitoring a call in compliance with a governmental regulation in a telecommunications network, comprising the steps of:
providing an application that regulates calls in compliance with the governmental regulation; and
providing a primary rate interface (PRI) for redirecting the calls to be regulated in accordance with the governmental regulation.

11. The method of claim 10, determining whether to regulate the calls based on a database.

12. The method of claim 10, redirecting voice signals over a B-Channel of the PRI.

13. The method of claim 10, redirecting call data over a D-Channel of the PRI.
